(19) United States
(12) Patent Application Publication
(10) Pub. No.: US 2026/0120589 A1
(43) Pub. Date: Apr. 30, 2026

(54) CLOSE-QUARTERS COMBAT SYSTEM

(71) Applicant: Ronald Claytor Lassiter, JR., Sheridan, WY (US)

(72) Inventor: Ronald Claytor Lassiter, JR., Sheridan, WY (US)

(21) Appl. No.: 18/933,547

(22) Filed: Oct. 31, 2024

(51) Int. Cl. G09B 9/00; E04B 1/343

(52) U.S. Cl. CPC G09B 9/003; E04B 1/34321

(57) ABSTRACT

A close-quarters combat training system has rails positioned to form a polygon. Each rail has an internal channel, and a cart with rollers can move along the rails. The cart has a rod depending from the cart, and the cart engages a panel that acts as a wall inside the training system. When the cart is positioned properly, the panel is pivoted to a desired orientation to form a linked wall. The panels may have openings to simulate windows and doors.

### BACKGROUND

### 1. Field

Adaptable building interiors for close-quarters combat training.

### 2. General Background and State of the Art

Close-quarters combat (CQC) is the clearance of opponents or criminals from buildings and structures in urban environments by military and police (SWAT) teams. Effective CQC requires extensive training, much of which occurs in close and closed environments of buildings and structures that soldiers, sailors, or police could encounter.

But buildings and structures vary. Some are single story; others have two or more floors, which stairs may connect. Some have long, narrow halls, but others don't. The wall materials also vary. Some have places for opponents to hide, and some have hiding places for the team members.

Existing buildings or constructions, especially those scheduled for demolition, may be offered to military or law enforcement as a source of training. They offer existing floor plans and spaces but lack options to change their floor plans. They also have conditions that add fire hazards and environmental health considerations such as asbestos, insulation, carpet, and other substances. Providing separate training buildings for all or even many possibilities can also be wasteful and expensive.

People being trained for CQC are usually highly qualified, so wasting their time in inefficient building designs is a drawback. Replacing walls, stairs, and doors in existing buildings to provide different training can be slow, expensive, and waste trainees' time. Present CQC facilities are cinderblock, framed, metal or hardened structures with existing floor plans. Even if the facility offers the option to change the floor plan, changing cannot be done rapidly within minutes or hours. The process also can be arduous. Changes typically involve tearing down walls and building new walls or structures. Construction delays also delay training.

The building differences become more serious when the target of the team such as a terrorist is in a known structure. Ideally, training for a mission against a particular building should occur in a simulated building comparable to the target building. The team may obtain building plans to simulate a target building, but if plans are unavailable, the team may obtain photos or may rely on descriptions from knowledgeable people. Constructing a building's copy in existing structures is time consuming, and delaying a mission against the target may be unjustified or imprudent.

### SUMMARY

The CQC system provides realistic expandable and modular wall system(s) that can be changed rapidly to maximize time for training. This flexibility can provide special operations hours of extra time for training without using the same floor plans repeatedly.

The CQC panels function as lightweight walls, which are movable through attachment to overhead supports or rails. The arrangement allows for the erecting, expanding, changing, and taking down the system as needed to meet training goals. The modular system can be erected in locations lacking existing walls structures. These structures can be warehouses, empty office spaces, or structures that might not be considered training locations because they lack existing walls or other inside structures.

The modular system can provide training coordinators repeatable and specific floor plan scenarios to practice specific combat clearance techniques and procedures. Coordinators can select single-or multiple-room floor plans and change the plans to meet training requirements. The coordinators can also repeat floor plans so the team can practice those plans to correct any mistakes.

A live-fire version can use panel materials like Kevlar® to prevent ricochets from risking team members from injury from live ammunition or explosives. The panels and other structures can be wired for lighting and other electric accessories like explosive access and breaching problems, ventilation, and clean up to maximize training time.

The CQC system gives training coordinators the options to design and select wall configurations to create desired floor plans and layouts of training facilities. The selected wall configurations and designed floor plans can be changed and reconfigured by the training coordinators, facilitators, or range managers to create the next configuration or floor plan design.

Specific training versions may include a close-quarters selectable system, a modular, selectable wall system enabling special warfare operators to conduct combat clearance specific to training goals. Another version is a close-quarters combat mobile system, a mobile version of the CQC selectable system, live-fire systems, or other selectable versions.

A CQC live-fire system enables the team to conduct live-fire combat clearance training operations with small arms weapons. A close-quarters combat breacher system lets the team conduct live demolition breaching operations in a combat clearance environment specific to training goals.

A CQC heavy access system provides training for heavy access through different versions of panel materials or structural features in a combat clearance environment. “Heavy access” is the use of all sizes of drills, saws, torches, and mechanical methods of entry through walls, buildings, or structural features. A close-quarters combat explosive ordnance disposal (EOD) access system lets the team train for heavier ordnance disposal.

Modular enhancements let the team practice in realistic settings. Enhancements may include lighting systems for overhead light sources for each room in the floor plan. Many warehouses have lighting systems providing uniform or close-to-uniform lighting throughout the warehouse, but they may be inappropriate for the needed lighting control in individual rooms. By using systems that connect electrical switches electronically to light sources or other systems used in buildings, light switches can turn lights and the other systems on or off in individual rooms.

Ventilation systems are another enhancement. They provide a method of ventilating training environment of hazardous fumes, dust, smoke, and other suspended particles inherent to the special ops training during shooting, breaching, EOD, and access operations.

A built-in video recording and playback system throughout the facility enables enhanced instruction.

Wall panels may be of different height, width, or shape, and panels may be extendable. Kevlar or other bullet-resistant material may cover walls during live-fire training. Kevlar also could be secured between outer panels while walls covered with Kevlar weave material create the desired level of bulletproof walls.

Depending on the building height, an overhead catwalk system could enable viewing platforms for trainers and team leaders to track and observe teams. This ability to observe training is a safety feature for more observers to watch live training and give immediate feedback to trainees after a training event.

### BRIEF DESCRIPTION OF THE DRAWINGS

FIG. 1A is a partial plan view of an arrangement of rails of applicant's close-quarters combat system.

FIG. 1B is an exploded view of structure in square 1B in FIG. 1A, and includes applicant's rails, supports and attachments, and a panel depending from one rail.

FIG. 1C is a perspective view of a setup of applicant's close-quarters combat system.

FIG. 2 is a perspective view of three panels of applicant's close-quarters system and its panels' relationship with the rails.

FIG. 3 is a perspective view of one panel of applicant's close-quarters system and its relationship with a rail.

FIG. 3B is a perspective view of four rails coming together at a fitting.

FIG. 3C is an exploded, perspective view of a panel depending from a rail.

FIG. 3D is a front view of a rail for holding up a fitting like the fitting of FIG. 3B.

FIG. 3E is a front view of two panels attached to each other with part of a third panel attached to one of the first, two panels.

FIG. 4 is a plan view of one setup of applicant's close-quarters combat system showing the panels, rails, and other structure.

FIGS. 5 through 9 are front view of panels applicant's close-quarters combat system can use. FIG. 5 is a full-size panel with a door and window. FIG. 6 is a half-width panel. FIG. 7 is a full-size panel with two windows. FIG. 8 is a quarter-width panel. FIG. 9 is a half-height panel.

FIG. 10 is a perspective view of the rail of applicant's close-quarters combat system and part of a cart that can move inside the rail.

FIG. 11 is a perspective view of the cart, its rollers and related structure used with the rail of applicant's close-quarters combat system.

FIG. 12 is a cutaway perspective view of a panel and related structure in of applicant's close-quarters combat system.

FIG. 13 is also a cutaway perspective view of a panel showing the its internal structure and ventilation.

FIG. 14 is a front view of a catwalk and its stairs or ladder inside a building.

### DETAILED DESCRIPTION

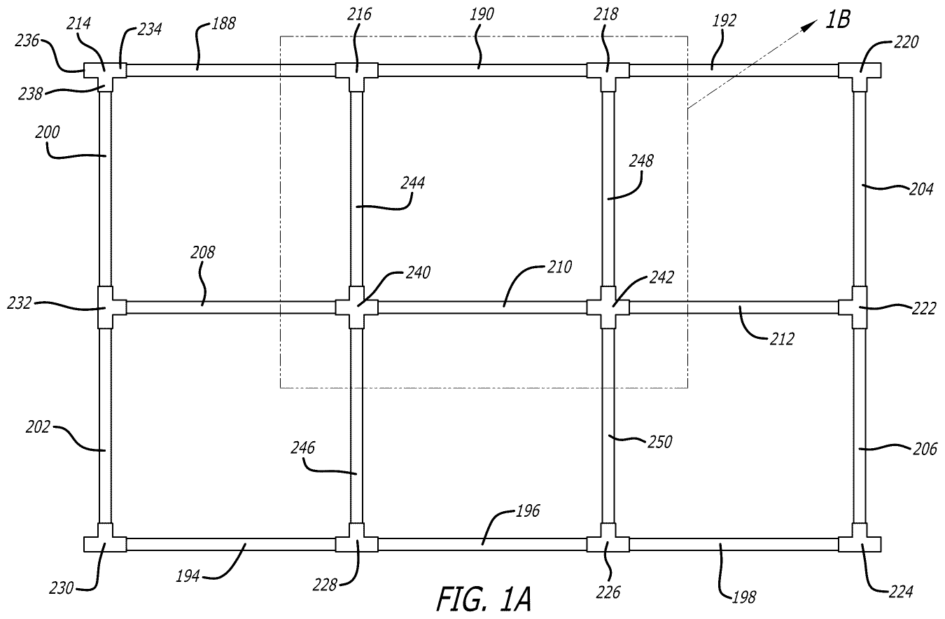

Applicant's close-quarters combat (CSQ) system is on floor 112 in building 110. See FIG. 1C. The building's ceiling is not shown. That building is one of many designs. The CSQ system could be set up outdoors too. In this application, “ceiling” means the overhead interior of existing rooms or buildings. The ceiling may be finished, but some ceilings, especially those in commercial buildings, may have exposed wood or metal joists, lighting fixtures, insulation, HVAC parts, and other items. Applicant's system may interact with the ceiling, but one-story CSQ systems in typical warehouse buildings may be spaced from the building's ceiling.

Warehouses and unfinished industrial or office buildings' long and wide expanses are useful for CSQ systems. Depending on the building's size, it may have vertical pillars or load-bearing walls for supporting the roof or a second story. Applicant's system can accommodate the pillars or load-bearing walls by using or avoiding them. Applicant's system also can be set up outside buildings, but doing so does not use advantages of building interiors.

Small Room: FIG. 1C shows applicant's system for a small dwelling or room 114. The room may be within building 110. Four rails 102, 104, 106, and 108 function as overhead supports for panels 132, 134, 136, and 138. Details of the rails' structure are discussed below.

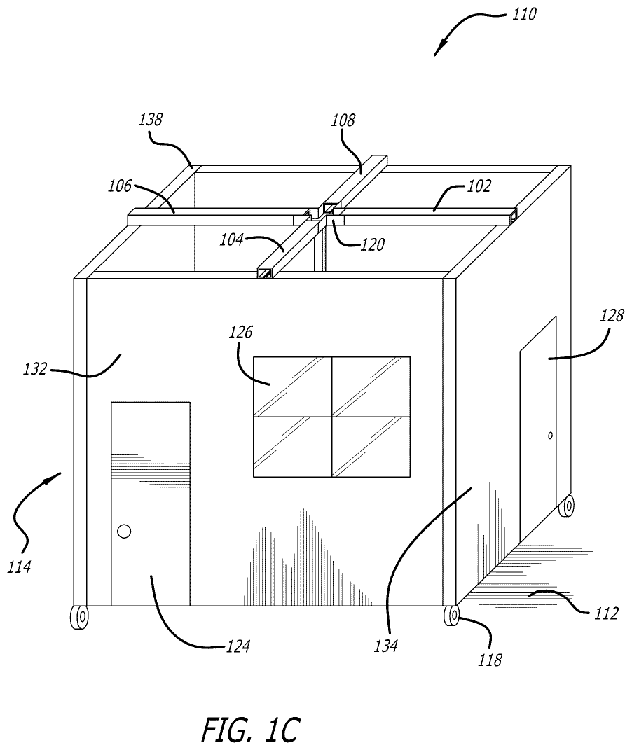

The proximal end of each rail fits into channels 122 in center fitting 120. See FIGS. 1C and 3B. In those figures, the tops of the channels are open, but the top could be closed. Optional fasteners (not shown) can secure the rails to the center fitting. Each rail's distal end supports a panel. Each panel 136 and 138 has an optional door 124 and 128, and panel 136 has a window 126. Details of the panel structures are discussed below.

Post 132 extends vertically from base 130 on the building's floor 112. See FIG. 3D. The material and height of the post and the weight of what the post supports affects its width or diameter, but FIG. 3D is not intended to suggest an apt size of the post. The top of the post support center fitting 120. See also FIG. 3B.

Room 114 can roll on optional wheels 118. Only three wheels attached at one corner of each panel are visible in FIG. 1C, but one, two, or more wheels attached elsewhere to each panel may be used for each panel to keep the bottom of each panel off floor 112 and limit the rails from pivoting downward.

Larger, Rectangular Setup: The remaining discussions relate to setups that use more than the four panels and components in FIG. 1C. FIG. 1B has four rails 144, 146, 148 and 150. Rails 144 and 148 extend in a first direction shown by arrow 152, and rails 146 and 150 extend in a second direction shown be arrow 154. Adjacent rails in FIG. 1B are at right angles to each other, so they form a square (if the rails are the same length) or a rectangle if two opposite rails are a different length from the other two rails. The drawings only show the rails intersecting at right angles, but adjacent rails could be angled to each other.

In FIG. 1B, one end of rail 144 fits into a channel 158 of fitting 156. The rail's other end fits into channel 162 of fitting 160. One end of rail 150 occupies another channel of fitting 156, and the rail's other end fits in channel 166 of fitting 164. Fitting 164 has three channels and will be along one side of the assembly (the side opposite the direction of arrow 154 in FIG. 1B). Fitting 168 also has three channels 170. To summarize, the channels of fitting 156 holds rail 144 and 150, fitting 164 holds rails 148 and 150, fitting 168 holds rails 148 and 146, and fitting 160 holds rails 144 and 146. The assembly adds other rails to the fittings. Rails 172 and 174 fit in channels of fitting 156 to add rails extending in the direction of arrows 152 and 154. FIG. 1B. Other rails like rail 178 attach to a channel like one in fitting 164 to extend its side of the assembly in the arrow's direction. Rail 178 attaches to fitting 168 to extend the assembly in the direction away from arrow 152.

FIG. 1B also shows panel or wall 176 depending from rail 144. How panels attach to the rails is described later in the application. Posts 180, 182, 184, and 186 mount on the building's floor and support a fitting 158, 169, 162, or 164. The fittings also could be supported from above by cables attached to the building's ceiling supports but it is likely that making different setups is easier if the fittings are supported on posts of the floor. The pattern in FIG. 1B can continue until reaching the assembly's desired size and shape.

FIG. 1A shows the rails in a 3×2 pattern. Rails 188, 190 and 192 are aligned with each other, and rails 194, 196, and 198 are opposite and parallel to the first three rails. Rails 208, 210 and 212 are between the first two sets and are parallel to both. Rails 200 and 202 are perpendicular to the first, three sets, and rails 204 and 206 are at the other end of the 3×2 arrangement.

Fittings 214, 216, 218, 220, 222, 224, 226, 228, 230, and 232 have three channels. See channels 234, 236, and 238 for fitting 214 (FIG. 1A). Channels 234 and 236 are aligned with each other, and channel 238 is perpendicular to the other two channels. Rail 188 mounts in channel 234, and rail 200 mounts in channel 238. FIG. 1A's setup does not use channel 236, but the channel is available for other arrangements.

Fittings 240 and 242 each have four channels because they receive four rails: rails 208, 210, 244, and 246 in fitting 240 and rails 210, 212, 248, and 250 in fitting 242 (FIG. 1A). Posts such as 180, 182, 184, and 186 (FIG. 1B) can support the fitting in FIG. 1A.

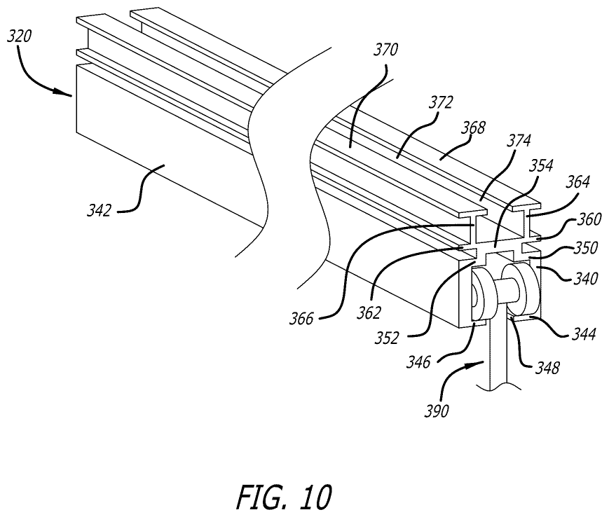

Rail and Cart Constructions: FIG. 10 shows a configuration of a rail such as rail 320. The other rails may share the same or similar constructions. Rails in other figures are simplified. Extruded aluminum is a choice for the rails because it is strong, lightweight, and its shape and including channels can be formed through extrusion.

Rail 320 includes two primary wall segments 340 and 342 that each extend upward from feet 344 and 346. (FIG. 10) The feet are spaced apart to form channel 348. Short side walls 350 and 352 extend inward from the primary wall segments 340 and 342 and curve or angle upward to top plate 354. Side edges 360 and 362 of the top plate extend beyond the intersection of the short side walls 350 and 352 with the top plate.

Webs 364 and 366 in FIG. 10 extend upward from the edges of top plate 354, and each web has a flat upper flange 368 and 370. The flat surfaces are spaced at 372 to allow access to upper channel 374.

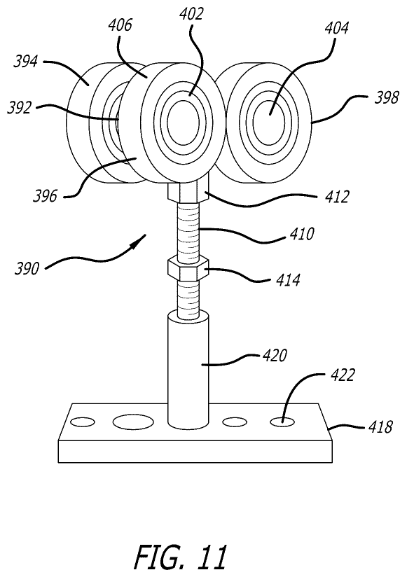

Cart 390 (FIGS. 10 and 11) moves along the rails. The cart includes a roller assembly with bed 392 (FIG. 11) having two pairs of rollers, front rollers 394 and 396, and rear roller 398. The fourth roller is hidden behind roller 398. Using four rollers makes the cart more stable and easier to move, but having fewer or more rollers may be acceptable. The rollers mount on axles 402 and 404 extending through the bed. The bed's material is rigid enough to keep the rollers aligned. The rollers may have a rubberized outside surface 406 or be of a material like polyurethane used for roller skate wheels. Bearings (not shown) around the axles also help rolling.

The rollers are spaced to fit in channel 348 between rail 320's primary wall segments 340 and 342. See FIG. 10, which shows cart 390 within the rail. The rollers' diameters are less than the distance between feet 344 and 346 and side walls 350 and 35. Low-friction sliders could be used instead of rollers, but the rollers that FIGS. 10 and 11 show, are an effective mechanism for moving cart 390 within the rails.

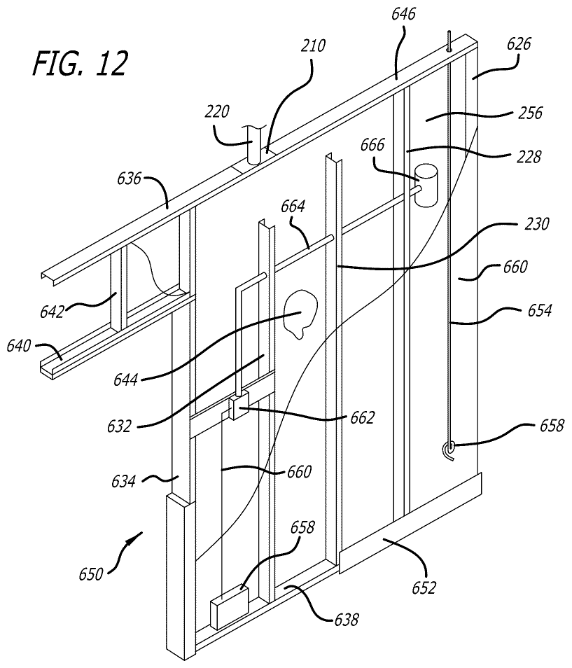

Rod 410 in the form of threaded bolt or post (FIG. 11) attaches to bed 392 and extends vertically downward between feet 344 and 346 of rail 320. See FIG. 10. The post may be screwed into threaded fitting 412 in the bed. The bottom end of bolt 410 screws into short post 420, which extends upward from pad 418. Fasteners (not shown) extend through bores 422 to attach the pad to the top of a panel like panel 450 (FIG. 12).

Cart 390 and pad 418 (FIG. 11) can pivot about bolt 410 to position parts depending from the pad to desired orientations.

Tightening nut 414 against short post 420 or against the bottom of fitting 412 keeps the post rigid and in a fixed vertical position. A second nut may be tightened against the other nut to maintain the other nuts' tightness.

As an alternative to threaded rod/bolt 412, the rod could have a quick release mechanism to allow its removal from cart 390. If so, the rod's threading may be unnecessary.

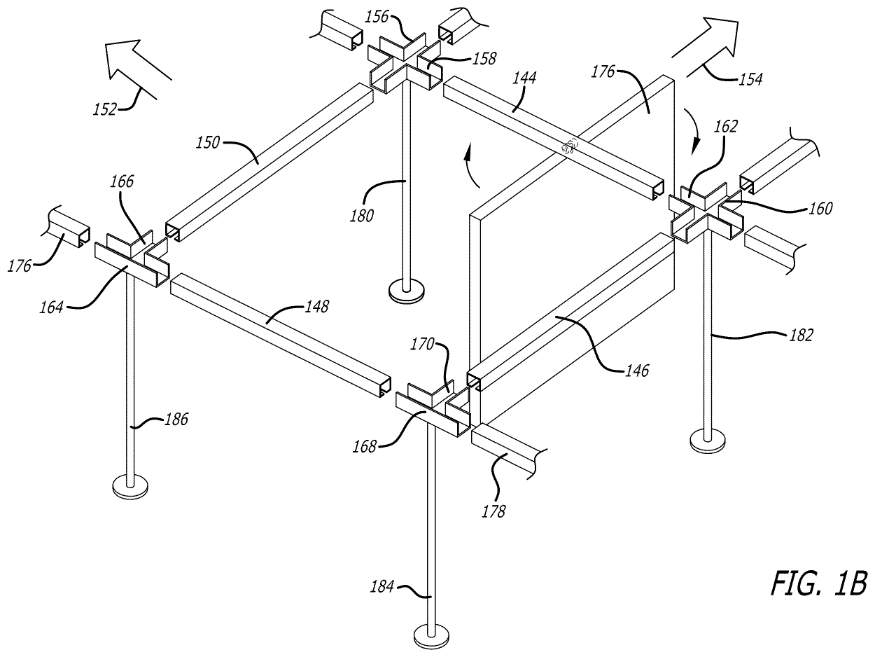

Panels: Panels depend from the rails and function as the system's walls. In FIG. 3, rollers 518 extend upward from pad 448 at the top of panel 430 into rail 432. The rail and roller assembly are simpler versions of those elements in FIGS. 10 and 11. The people responsible for arranging the panels move the panels along the rails until the panels are in their desired position. Each panel then is rotated to its desired angle. FIG. 2 shows three panels 430, 450, and 452 depending from rail 432. The panels can move together or separately along the rail.

FIGS. 3C, 12 and 13 show assorted panel constructions. Panel 500 (FIG. 3C) is rectangular like a typical building wall, but using other shapes is possible. Having angled top, bottom or sides may be useful to mimic walls known to exist in target buildings, however. Panel 500 may be 8 ft. (2.4m) tall and 10 ft. (3m), 12 ft (3.6m), or 14 ft. (4.3m) wide (all metric conversions are approximate) but other sizes can be used. The panels' height can vary also.

Unlike existing load-bearing structures in warehouses, open office spaces, or any area large enough to accommodate applicant's system footprint, applicant's panels are not load bearing. That lets them weigh less so they can be moved and positioned more easily.

Panel 500 has top and bottom brackets 502 and 504 (FIG. 3C) separated by three studs 506, 508, and 510. The brackets are U-shaped aluminum channels with the open sides facing each other. Steel brackets and studs could be used, but steel is heavier than aluminum, which would make moving panel 500 more difficult and require more robust other structure. The studs also are aluminum to lower weight, but they may be steel or even wood. Triangular braces 512 and 514 maintain the brackets and studs square. Plates 520 and 522 are secured to the studs and brackets to form the panel's outside. The plates may be sheet aluminum or steel, drywall, fabric, Kevlar®, or other suitable outside surfaces.

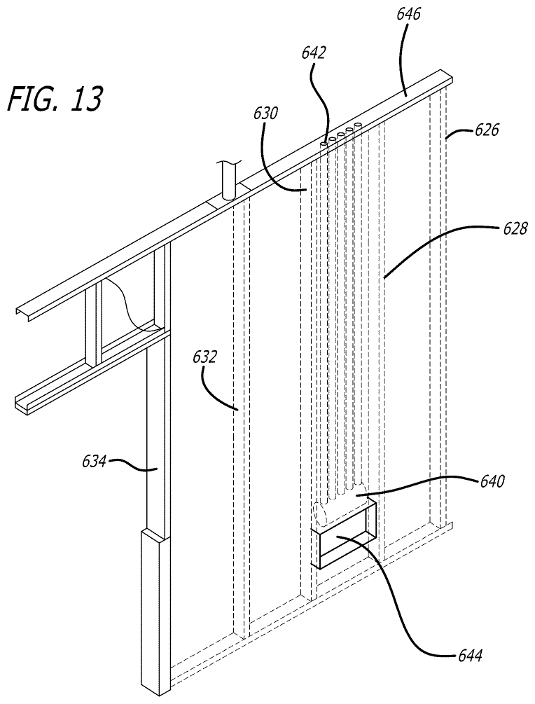

Panels 650 and 652 (FIGS. 12 and 13) are like panel 600 in FIG. 3C, but the former have added structure. Studs 626, 628, 630, 632, and 634 (FIGS. 12 and 13) are secured to top and bottom supports 636 and 638. The supports and studs may be made from aluminum. Pad 618 (FIG. 11) attaches to the panel's top support.

Panels 650 and 652 (FIGS. 12 and 13) can accommodate a door (not shown in those figures). A header formed by horizontal bracket 640 and supported by vertical brace 642 enclose the top of the door's opening.

To decrease the panels' weight, its front and rear may be covered with aluminum sheets like sheets 520 and 522 in FIG. 3C, fabric, or other lightweight material. Aluminum sheets and fabric may not be durable enough for extended use with team members bumping into them or hitting them with weapons. If so, other material could replace aluminum. Aluminum also may be too weak to use during live-fire training, so other materials like Kevlar® can replace or cover the aluminum panels. The panel also could be filled with Kevlar batting 644. See FIG. 12.

The internal parts in FIGS. 12 and 13 are discussed below.

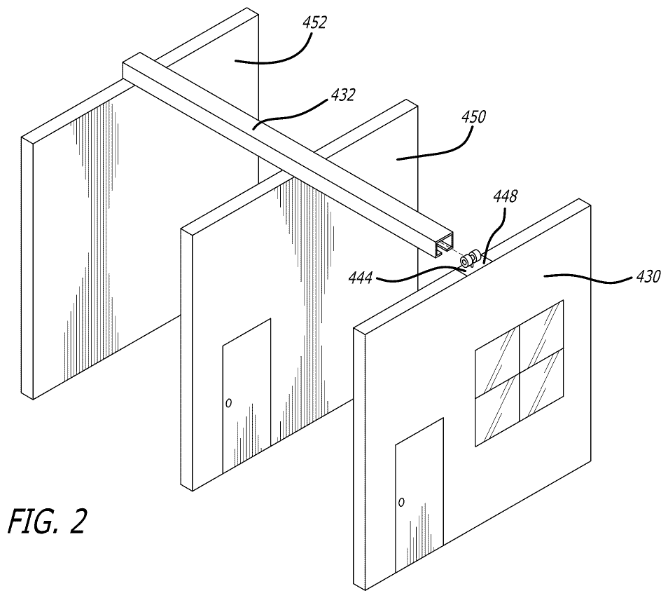

System of combined rails and panels: FIG. 4 shows one arrangement of the combat system's element. Three rails 700, 702, and 704 extend in a straight line. Other rails extend in different straight lines parallel or perpendicular with rails 700, 702, and 704. When the rails are positioned during setup, the rails may not extend precisely in a straight line, but for this description, the drawings show the rails in straight lines and intersect or be next to second rails 706 and 718 at right angles.

Posts like post 180 in FIG. 1B support the rails though FIG. 4 does not show the posts. But see posts 180, 182, 184 and 186 in FIG. 1B. FIG. 4 also does not show fittings like fitting 120 in FIG. 3B though fittings would be useful in the FIG. 4 arrangement. Where fittings are not used, any clip or connectors that can be attached to and removed from each rail end could secure the rails. Quick-release connectors, which allow faster setup and takedown of the rail, may be preferable.

Instead of supporting the rails on posts, the rails may hang from cables attached to the building's ceiling. Repositioning hanging rails to change the CQC arrangements is more difficult than positioning the rails on posts, however.

Rails 706 and 718 respectively attach to each other or to a fitting like fitting 120 (FIG. 3B) and are perpendicular to rails 704 and 710 (FIG. 4).

Rails 700, 702, and 704, rails 710, 712, and 714 are aligned. The rails on one side are parallel with those on the other side. See FIG. 4. Rails 706 and 708 are aligned, as are rails 716 and 718. Rails 700 and 718 mount at right angles to each other as do rails 704 and 706, 708 and 710, and 714 and 716. Thus, the rails in FIG. 4 that this paragraph mentions form a rectangle.

The ends of the rails that meet at a right angle may be spaced from each other to allow rollers like rollers 394, 396, and 398 of cart 190 (FIGS. 10 and 11) to enter the rail without interference from the adjacent rail. If fittings like fitting 220 or 242 are used, the ends of the rails in the fitting can be removed from the fitting's channels for room to push the rollers into the rail. Removing bolt 410 from the rollers also lets the rollers be inserted in the rail. After the rollers pass the lower rail, the bolt can be attached again to its rollers. Depending on the size of the parts, rod/bolt 520 also could be removed from the cart to allow inserting the cart into the rail's end.

Panels are shown as dashed lines with widths wider than the rails'width. For example, see rail 700 and panel 740 in FIG. 4. The rails supporting panels like panels 476, 478, and 480 are not shown in FIG. 4 to limit and extra lines in the drawing.

Where two rails meet at a right angle without a fitting, angling the ends of the rails like a miter can allow entry of the rollers. The rollers also could be inserted into the rails before the rails positioned in their FIG. 4 orientation, or the end of one rail could be raised to let the rollers be inserted into the other rail.

FIG. 4 shows four other sets of rails. Rails 770, 772, and 774, rails 776, 778, and 780, and rails 782, 784, and 786, are aligned and parallel to the first 700, 702, 704 and second set 710, 712, 714 of rails. Aligned rails 788 and 790 are perpendicular to the first and second sets of rails.

Especially for shorter buildings, rails could attach to, be parallel to, or extend between overhead joists. Building joists in tall warehouse buildings may be too high to cooperate with the rails.

Attachments: Lighting can come from the overhead lighting on or below the building's ceiling. Bright lights (not shown) can shine through windows to simulate sunshine. Overhead lights 730, 732, 734, 736, and 738 (FIG. 4) mount on or next to rails to provide internal lighting.

The inside of panels may include electric wiring and battery power. The CQC instructors and monitors can use Wi-fi or Bluetooth to control electrical power for the panels, but the systems are designed for team members to activate and deactivate lights and other electric devices during exercises. For team member control, panel 650 (FIG. 12) includes a battery and an inverter (DC to AC converter) 658, which connects through conduit 660 to junction box 662. The junction box may have a switch (not shown) or elsewhere, which lets team members turn on overhead lamps, lamps attached to the electric outlet at opening 658, and other electric devices.

Electric conduit 664 extends to another junction box 666 (FIG. 12). Another conduit 654 extends through top 646 of the panel, through the second junction box, and to opening 658 in aluminum sheet 654. The end of the conduit extending through the top of the panel can connect to a conduit in an adjacent panel and to an AC current source, which eliminates the need for the battery and inverter. The conduit can attach to an electric outlet (not shown). Electric elements like lamps, fans, and overhead lighting can be controlled through Wi-fi, Bluetooth, or other electronic systems. Caséta by Lutron, Pico original remote for switches, Model No. PJ2-2B-G, is an example of an electronic system that can be used. See https://www.casetawireless.com/us/en/products/pico-remotes (accessed Jan. 25, 2024).

Outside stud 626 (FIG. 12) may have one or more connectors that attach to an adjacent panel when the sides of the panels are positioned against each other.

One or more panels may have a ventilation system. FIG. 13 shows one arrangement that includes fan 750, which draws air through ducts 752. See FIG. 13. The ducts extend through the top 646 of a panel into register 754.

The FIG. 4 arrangement has three exterior panels 440, 442, and 444 (dashed lines) on a first side hanging from aligned rails 400, 402, and 404. Three exterior panels 450, 45 and 454 on the second, opposite side hang from aligned rails 410, 412, and 414. Aligned rails 406 and 408 are on a third side of the arrangement, and panels 446 and 448 hang from those rails. The fourth set of aligned rails 416 and 418 and their hanging exterior panels 456 and 458 are opposite rails 406 and 408. Though every outside rail in FIG. 4 has a hanging panel, one or more rails could be left without a panel to simulate an opening to the interior. Openings as wide as the rails could simulate openings sized like garage doors.

For a particular setup, cart 190 with its depending panel is pushed or pulled along the rails until the cart is positioned properly. The panel then is pivoted to a desired orientation. The process continues with other carts and panels. When the panels are pivoted to their desired positions, the side of adjacent panels may be attached together to form a long, linked wall.

Rails 500, 502, 504, and 506 form a small room in FIG. 4. Each rail has a panel (not shown). Rollers 510, 512, 514, and 516 let the panels move from adjacent rails to positions below the desired rail. The panels forming the small room may have windows and doors, or other openings as described below.

Three panels 820, 822, and 824 are in temporary storage in FIG. 4. Storing them from a rail makes them available for different setups.

The FIG. 4 arrangement shows two more panels, The panel below rail 826 is full width, and the panel below rail 828 is one-half width. Their positions in FIG. 4 let team members hide behind one or both, and the team can advance in the space between the two panels.

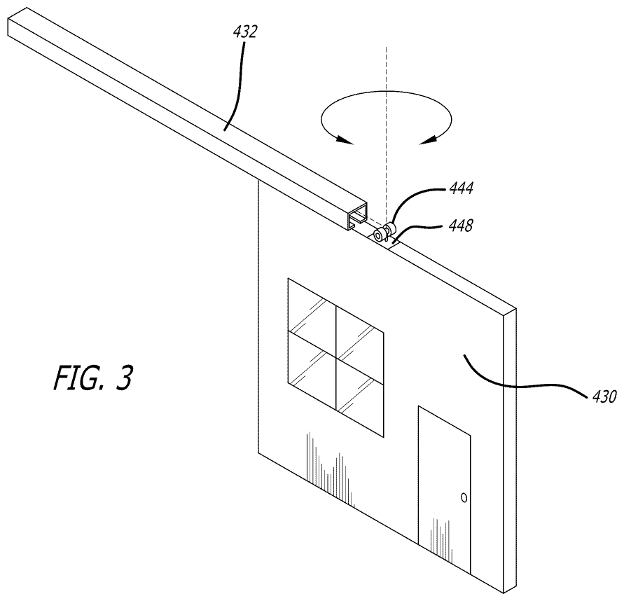

Panel Designs: FIGS. 5 through 9 show some of the many designs for the panels. Panel 870 in FIG. 5 is a full panel with glass or plastic window 872 and door 874, and doorknob 876 connects to a strike plate (not shown) on the panel. The arrangement trains team members entering buildings and rooms through doors. Instead of standard pivoting doors, a garage-type, a vertically opening door, or a pocket door could be used in the door opening.

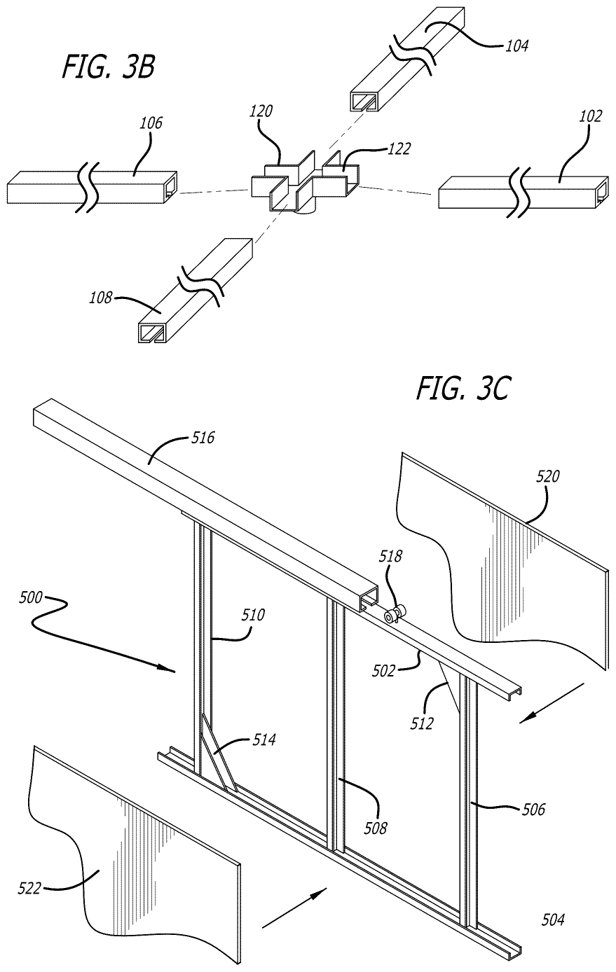

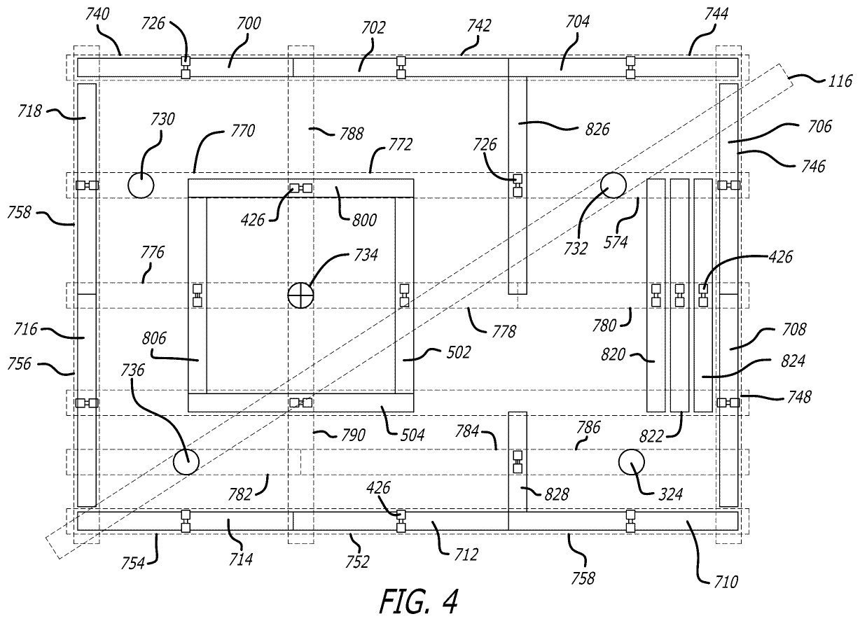

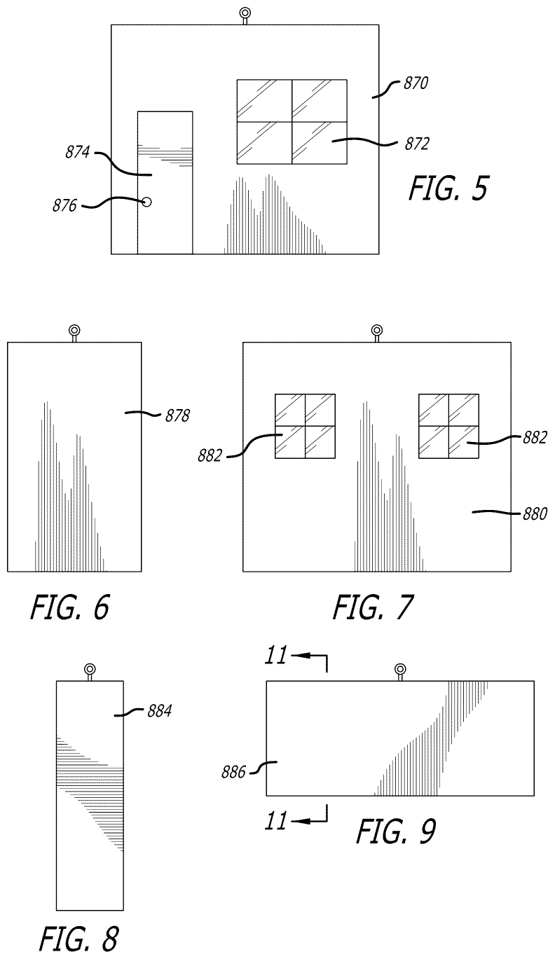

The panels may be partial widths such as half-width panel 878 (FIG. 6) (see also panel 828 in FIG. 4) and quarter-width panel 884 (FIG. 8). The panels may be half-height like panel 886 (FIG. 9). The panels in FIG. 5-9 have rollers at the top of the panel to move along a rail.

The choice of different panels also varies the CQC arrangement. The interior and exterior panels can emulate panels in floor plans of residences or commercial facilities.

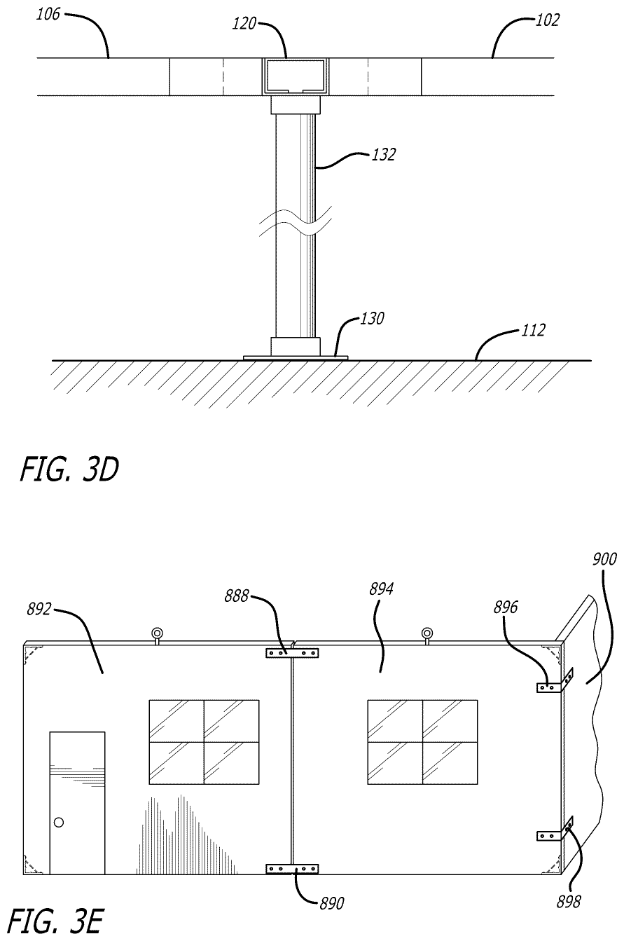

Wall 800 in FIG. 7 is a full-size panel with two window openings 882. The openings are the same size in the figure, but they can be different sizes or shapes. The number of windows can also vary. Depending on the training exercise, glass or plastic windows could mount in the window openings, or the window openings could be empty.

The panels may be partial widths such as half-width panel 350 (FIG. 6) (see also panel 58 in FIG. 4) and quarter-width panel 35 (FIG. 8). The panels may be half-height like panel 854 (FIG. 9). The panels in FIG. 5-9 have rollers to move along an overhead support. If Panel 886 (FIG. 9) reaches the floor, it could mount on the floor or hang by cables from its rail. Thus, it is at the top half of a panel. With supports (not shown) extending from the overhead support to the panel, the panel could mount on the bottom-half for a wall. The panel also could mount on the floor.

The FIG. 4 arrangement is an example of the number and positions of panels and shows how the panels can be added, removed, or rearranged. Pivoting panels about their cart 190 affects the panel's orientation and is a way to have different setups. For example, repositioning the rails above panels 470, 472, and 474 and other rails/panels can change the size or position of the small room formed by panels 500, 502, 504, and 506. The small room may be positioned in the larger space. See the room formed from rails 800, 802, 804, and 806 in FIG. 4. Merely changing where doors and windows are positioned changes the CQC exercise.

Limiting the movement of the panels when the arrangement is finished is desirable. Since the panels function as walls, having a panel swing when a team member pushes on it would not be realistic. Adjacent panels may attach to each other to limit panel movement. Brackets 888 and 890 mount on panels 892 and 894 (FIG. 3E). The brackets can attach to receivers on the panels to make attachment easier. Brackets 896 and 898 attach panels 894 and 900 together.

Because panel 900 is at a right angle to panel 894, moving either is more difficult.

The bottom of the panels also could have short posts or other members that engage holes in the floor. The holes would be positioned to accommodate the posts or most possible positions.

Catwalk: Catwalk 116 extends diagonally over the attached rails in FIG. 4. Structure from the building's ceiling can support the catwalk. If the catwalk is long enough to extend beyond the outside of the rails, the catwalk can mount on structure mounted on the floor. Multiple catwalks may be desirable to let trainers position themselves in preferred positions. If the distance between the building ceiling and the rails is too small, there may be no room for an overhead catwalk from which trainers and coaches can track the teams.

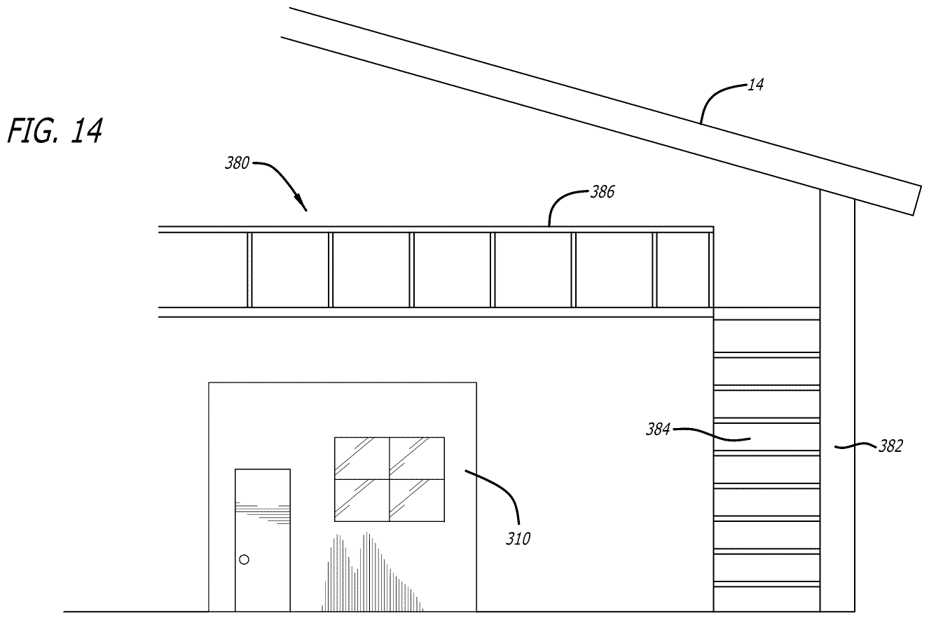

The building walls also can support a catwalk. In FIG. 14, catwalk 380 is shown above panel 310. The catwalk extends from building wall 382 to another building wall, an internal support, or a post (none shown in FIG. 14). Stairs or ladder 384 lets people climb from the floor to catwalk 340, and railing 386 guards against people falling from the catwalk.

Video monitors also can be placed where wanted, especially if there is no catwalk from which people can observe. The video monitor can connect by cables or wirelessly to a video control center.

The description is illustrative, not limiting and is for example only. Although this application shows and describes examples, those having ordinary skill in the art will find it apparent they can make changes, changes, or alterations. Many examples involve specific combinations of method acts or system elements, but those acts and those elements may be combined in other ways to meet the same goals. Acts, elements, and features discussed only with one embodiment are not intended to be excluded from a similar role in other embodiments.

“Plurality” means two or more. A “set” of items may include one or more of such items. The terms “comprising,” “including,” “carrying,” “having,” “containing,” “involving,” and similar words in the written description or the claims are open-ended, i.e., each means, “including but not limited to.” Only the transitional phrases “consisting of” and “consisting essentially of” are closed or semi-closed transitional phrases regarding claims. The ordinal terms like “first,” “second,” “third,” etc., in the claims don't by themselves connote any priority, precedence, or order of one claim element over another or the temporal order in which acts of a method are performed. Instead, they merely are labels to distinguish one claim element having a certain name from another element having the same name (but for the ordinal term's use). Alternatives like “or” include one or any combination of the listed items.

I claim:

1. A close-quarters combat system comprising:
at least one rail mounted above a floor, the at least one rail having a top and a bottom, a channel at the bottom of the at least one rail, the channel having a top and bottom, the bottom of the channel having spaced-apart feet;
a cart movable within the channel for positioning the cart, the cart having a rod having a first end adjacent the cart and a second end depending from the cart;
a panel having a top surface;
the second end of the rod being attachable to the panel, the panel being mounted for pivoting with respect to the cart when the cart is positioned in a chosen location in the at least one rail.

2. The close-quarters combat system of claim 1 wherein at least one rail has opposing ends, at least one opposing end being open to allow a cart to be inserted into the open end.

3. The close-quarters combat system of claim 1 wherein the cart comprises at least one roller being capable of contacting the channel.

4. The close-quarters combat system of claim 1 further comprising a pad mounted on the top surface of the panel, wherein second end of the rod attaches to the pad.

5. The close-quarters combat system of claim 1 wherein the panel has two, spaced-apart walls and internal joists separating and supporting the spaced-apart walls.

6. The close-quarters combat system of claim 4 further comprising an opening through the panel to simulate a window.

7. The close-quarters combat system of claim 4 further comprising an opening through the panel and a door mounted in the opening.

8. A close-quarters combat system comprising:
rails mounted above a floor, the rails forming a polygon shape of at least one, first rail extending in a first direction, at least one second rail extending in a second direction, and at least a third rail extending in a direction to be adjacent the first rail;
a cart movable within at least one rail;
a panel depending from the at least one rail, positioned along the at least one rail and pivotally mounted with respect to the at least one rail.

9. The close-quarters combat system of claim 8 wherein at least two rails are aligned with each other in an end-to-end straight line.

10. The close-quarters combat system of claim 8 wherein the panel has two, spaced-apart walls and internal joists between the walls.

11. The close-quarters combat system of claim 10 wherein at least one of the two spaced-apart walls is formed of aluminum.

12. The close-quarters combat system of claim 8 further comprising a catwalk mounted at a height above at least one rail.

13. The close-quarters combat system of claim 8 further comprising an overhead light mounted to at least one rail.

14. A method of erecting a building interior comprising:
supporting a group of rails in a desired pattern above a floor;
inserting at least one end of each rail into a fitting, each fitting having at least one channel extending in a direction for positioning the rails in a desired direction;
hanging a panel from at least one moveable cart;
inserting a moveable cart in at least one rail; and
positioning the panel and setting its direction relative to the rail from which the panel hangs.

15. The method of claim 14 further comprising securing adjacent panels to each other.
